(19) United States
(12) Patent Application Publication
(10) Pub. No.: US 2007/0258522 A1
(43) Pub. Date: Nov. 8, 2007

(54) Creation and compression of video data

(76) Inventor: Michael James Knee, Petersfield (GB)

Correspondence Address: PEARL COHEN ZEDEK LATZER, LLP, 1500 BROADWAY 12TH FLOOR, NEW YORK, NY, 10036, US

(21) Appl. No.: 11/797,693

(22) Filed: May 7, 2007

(30) Foreign Application Priority Data
May 8, 2006 (GB) 0609050.0

(51) Int. Cl. H04N 11/02; H04N 7/12

(52) U.S. Cl. 375/240.16; 375/240.26

(57) ABSTRACT

This invention concerns the creation and compression of video data and is particularly relevant to MPEG and similar methods of video compression. In accordance with the invention, uncompressed video data including synthetic video data, for example representing a caption or logo, is accompanied by compression coding parameters derived from operator action, or control data, used during creation or modification of the video data. At least one of these accompanying compression coding parameters is used in a compression of the uncompressed video data.

### CROSS REFERENCE TO RELATED APPLICATION

This application claims priority from United Kingdom Patent Application No. GB 0609050.0, filed May 8, 2006, which is hereby incorporated by reference herein in its entirety.

### FIELD OF INVENTION

This invention concerns the creation and compression of video data and is particularly relevant to MPEG and similar methods of video compression.

### BACKGROUND OF THE INVENTION

A typical video compression encoder (for example an MPEG-2 encoder according to the ISO/IEC 13818-2 standard) makes an analysis of its input video in order to make decisions on how the video will be coded. These decisions include whether a particular frame will be described as the difference from a prediction, and if so, which other frames will be used to form the prediction, and how the transmitted data will be quantised. Motion compensated predictions require the encoder to analyse motion and create motion vectors. The quality of the decoded video (i.e. the transparency of the coding process) is dependent on the quality of the coding decisions and motion measurement.

European Patent EP 0 913 058 describes how coding decisions and related information can be retained in a compression decoder and carried with the decoded video for use in a subsequent compression process, and European Patent EP 1 051 851 describes how video that has not been previously encoded can be analysed and the results carried with the video for use in a compression encoder.

### SUMMARY OF THE INVENTION

The inventor has appreciated that there are some situations in which coding parameters can be created as part of the video origination process enabling higher quality compression to be achieved without the need for high-quality video analysis in the compression encoder. In particular, much video content is created without the use of cameras. For example: captions and subtitles are synthesised from text and formatting data; channel identification logos and clocks are synthesised from stored data; and, animated or stationary graphics may be created on a computer workstation.

The invention consists in one aspect of video origination apparatus wherein the video output is created or modified in response to the actions of an operator, or received control data; the said apparatus having an uncompressed video output and an output of compression coding parameters; characterised in that at least one of the said compression coding parameters is derived from the said operator action or received control data.

In another aspect the invention consists of video modification apparatus wherein an uncompressed first video input signal is combined with at least a second uncompressed video signal created or modified in response to the actions of an operator, or received control data; the said apparatus having an uncompressed video output comprising the combination of the said first and second video signals and an output of compression coding parameters; characterised in that at least one of the said compression coding parameters is derived from the said operator action or received control data.

The compression coding parameters may include MPEG picture type information. The compression coding parameters may include at least one motion vector. The compression coding parameters may include prediction modes to be applied to defined frames or parts of frames. The compression coding parameters may include a quantisation parameter.

In a further aspect the invention consists in a video compression method in which the uncompressed output of video origination apparatus is compressed wherein the output of the said video origination apparatus is created or modified in response to the actions of an operator, or received control data; characterised in that the said uncompressed output is compressed according to at least one compression coding parameter derived from the said operator action or received control data.

In a yet further aspect the invention consists in a video compression method in which the uncompressed output of video modification apparatus is compressed, wherein an uncompressed first video input signal is combined with at least a second uncompressed video signal created or modified in response to the actions of an operator, or received control data; characterised in that the said uncompressed output is compressed according to at least one compression coding parameter derived from the said operator action or received control data.

Suitably the said uncompressed first video input is accompanied by related compression coding parameters and the said uncompressed output is compressed according to at least one compression coding parameter taken from the said compression parameters related to the said uncompressed first video input.

### BRIEF DESCRIPTION OF THE DRAWINGS

The invention will now be described by way of examples with reference to the drawings in which:

FIG. 1 shows compression of the output of a video origination device according to a first exemplary embodiment;

FIG. 2 shows compression of the output of a Logo/Caption Generator and inserter according to a second exemplary embodiment; and

FIG. 3 shows compression of the output of a video mix/effects processor fed from a video origination device according to a third exemplary embodiment.

### DETAILED DESCRIPTION OF THE INVENTION

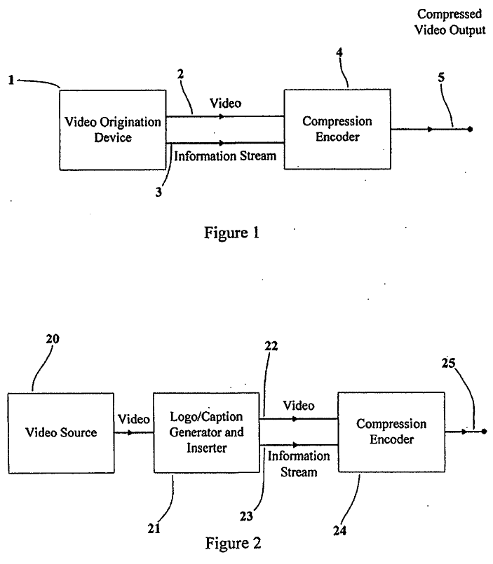

A first exemplary embodiment of the invention is shown in FIG. 1. A video origination device (1) produces a video signal (2) and an information stream (3). The device (1) may be a caption or logo generator or a graphics work station, and its video output may be moving or stationary. The video signal (2) may be a serial digital component data stream or any other uncompressed video format.

The information stream (3) comprises information to assist the compression of the video (2). This could include at least any of the following elements:

Prediction methods to be applied to spatial or temporal segments of the video.

Quantisation parameters to be applied to data derived from spatial or temporal segments of the video.

Motion vectors applicable to all or part of the video. These vectors may be absolute, i.e. describing motion speed and direction, or relative, i.e. describing motion between two defined frames.

Whether the video is interlaced or progressively scanned.

Information about the temporal sampling of the video such as “field dominance” or 3:2 pulldown sequence information.

This information is generated from the same data as is used to create the caption or logo; and, the origination device (1) will usually have prior knowledge of such data. For example, if a scrolling caption is generated, the speed and direction of motion requested by an operator can be used to create motion vectors for the pixels of the caption. This information will be more accurate and easier to obtain than equivalent information derived by analysis of the video (2). Similarly, decisions about prediction modes and quantisation can be derived from accurate and unambiguous knowledge of the caption or logo.

The stream (3) may also include information relating to compression which is not related to the nature of the video content; for example, a desired MPEG group-of pictures (GoP) sequence.

The information stream (3) could take the form of the “re-encoding data set” defined in SMPTE standard 327M. It could be carried in the same signal as the video (2), perhaps replacing the least-significant chrominance bit; alternatively, it could be a separate signal associated with the video (2). It will be apparent that the association or coding must enable the information in the stream to be related to the appropriate spatial and temporal elements of the video, for example: frames, coding-blocks or pixels.

A compression encoder (4) compresses the video (2) to give a compressed output (5). This output may be streaming data, for example an MPEG data stream; or, a file in an associated storage device.

If the encoder (4) takes all its coding decisions, motion vectors and video format information from the information stream (3), the encoder can be of simple design (i.e. it can be a “dumb” encoder). It is also possible for only some parameters to be taken from the information stream, perhaps only motion vectors. The information stream may not contain all the parameters necessary to define the video coding and some parameters may be taken from the stream while others are determined in the encoder. Another possibility is that the information (3) may require some processing before it can be used by the encoder (4); for example, it may be necessary to convert absolute motion vectors into motion vectors between defined frames. The optimum arrangement will depend on system considerations, in particular whether it is practicable for all the relevant information to be available to the generator (1).

A second exemplary embodiment of the invention is shown in FIG. 2.

It is often the case that the output of a caption or logo generator is not required to occupy the whole image area. It is very common for captions or logos to be “keyed into” a video signal so that an area of the picture defined by the caption or logo generator is replaced by its output. The shape and size of the area which is replaced may vary in dependence upon movement of the inserted caption or logo.

In FIG. 2, a video source (20), which may, for example, be a video camera, feeds a caption or logo generator and inserter (21). The caption or logo generator or inserter (21) inserts a caption or logo into the video received from the video source (20). As well as the combined caption and video (22), the generator and inserter (21) outputs an information stream (23) which contains information to assist the compression coding of the caption or logo elements of the combined video (22). The stream (23) refers only to the caption or logo because the generator and inserter (21) has no information about the other parts of the picture and does not analyse its video input.

A compression encoder (24) compresses the video (22) to create a compressed video stream or file output (25). This encoder must analyse those parts of the video (22) which do not contain material generated and inserted by the block (21), but can use the information stream (23) to determine how the caption or logo should be coded.

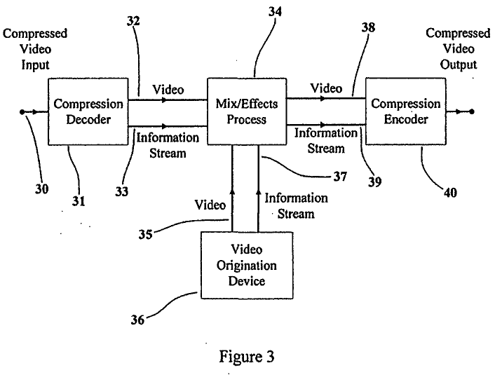

A third exemplary embodiment is shown in FIG. 3.

A compressed video input (30) is decompressed in a decoder (31) which provides both decoded video (32) and an information stream (33), containing information about the parameters used in the compression of the video (30). A mix/effects process (34) combines the video (32) with a second video signal (35) from a video origination device (36). This combination may be any of the well-known video combination techniques such as: inlay, wipes, other keying techniques, mixing, non-additive mixing etc. If keying is involved, the video (35) may include a key signal, or a key signal may be associated with it and input to the mix/effects process (34).

The origination device (36) provides an information stream (37) containing parameters to assist the coding of the video (35). These are obtained directly from the video origination process, and are not obtained by analysing the video (35).

The mix/effects process (34) provides a combined video output (38) and an information stream (39). This information stream (39) contains parameters to assist compression of the video (38) in a compression encoder (40). The information stream (39) may contain all the information from the information streams (33) and (37) or may only contain those parts of these information streams which relate to the video (38). In any event it will be necessary for the elements of the information stream (39) to be associated with relevant spatial and temporal segments of the video (38). This is achieved automatically if the information stream (39) is encoded into the video (38) (for example in a low-significance bit). Another option would be to combine the streams (33) and (37) with a key signal and output the combined streams and the key as the stream (39).

The compression encoder (40) compresses the video (38), making use of the information stream (39) to avoid or reduce the need for analysis of the video (38); and, to avoid cumulative compression impairments by ensuring that the previously compressed parts of the video (38) (i.e. the parts of the video (32) contributing to the video (38)) are compressed in the same way that they were compressed in the compressed video (30).

In all of the above-described embodiments of the invention there is more than one source of coding parameters for the compression encoder:

Video analysis by, and control input to, the compression encoder itself;

Information embedded in, or associated with, the encoder's video input; and,

In the case of the system shown in FIG. 3 there may be two separate sets of information embedded in, or associated with, the video input.

It will be preferable for the system to prioritise these sources of information to achieve the optimum coded video output; usually by giving “primacy” to one of these sources of coding parameters. Alternatively, the compression encoder may evaluate all sources of coding parameters available to it and decide the most appropriate on the basis of a quality measure relating to the coded output.

In the foregoing description, reference has been made to various functional blocks or entities. It will be recognised that the function of each block may be performed by dedicated hardware, by hardware containing some dedicated and some programmable elements or by software capable of running on video or general data processing apparatus. In particular but not exhaustive examples, the present invention may be implemented in software running on a microprocessor or other programmable element provided within a logo or caption generator; as code forming part of logo or caption generation software; as software within a digital special effects generator or as software within a computer generated film or video environment.

1. Video origination apparatus having an uncompressed video output wherein the video output is created or modified in response to the actions of an operator or received control data; the said apparatus comprising an output for compression coding parameters, wherein at least one of the said compression coding parameters is derived from the said operator action or received control data.

2. Apparatus according to claim 1 wherein the compression coding parameters include MPEG picture type information.

3. Apparatus according to claim 1 wherein the compression coding parameters include at least one motion vector.

4. Apparatus according to claim 1 wherein the compression coding parameters include prediction modes to be applied to defined frames or parts of frames.

5. Apparatus according to claim 1 wherein the compression coding parameters include a quantisation parameter.

6. Video modification apparatus wherein an uncompressed first video input signal is combined with at least a second uncompressed video signal created or modified in response to the actions of an operator, or received control data; the said apparatus having an uncompressed video output comprising the combination of the said first and second video signals and an output of compression coding parameters wherein at least one of the said compression coding parameters is derived from the said operator action or received control data.

7. Apparatus according to claim 6 wherein the compression coding parameters include MPEG picture type information.

8. Apparatus according to claim 6 wherein the compression coding parameters include at least one motion vector.

9. Apparatus according to claim 6 wherein the compression coding parameters include prediction modes to be applied to defined frames or parts of frames.

10. Apparatus according to claim 6 wherein the compression coding parameters include a quantisation parameter.

11. A video compression method in which the uncompressed output of video origination apparatus is compressed wherein the output of the said video origination apparatus is created or modified in response to the actions of an operator, or received control data; and the said uncompressed output is compressed according to at least one compression coding parameter derived from the said operator action or received control data.

12. A video compression method in which the uncompressed output of video modification apparatus is compressed, wherein an uncompressed first video input signal is combined with at least a second uncompressed video signal created or modified in response to the actions of an operator, or received control data; wherein the said uncompressed output is compressed according to at least one compression coding parameter derived from the said operator action or received control data.

13. A video compression method according to claim 12 wherein the said uncompressed first video input is accompanied by related compression coding parameters and the said uncompressed output is compressed according to at least one compression coding parameter taken from the said compression parameters related to the said uncompressed first video input.

14. Video origination apparatus comprising: means for receiving a text or computer graphics input; means for receiving at least one control parameter associated with said text or computer graphics; means for synthesising a video output by at least in part from said text or computer graphics and from said control parameter; and means for deriving from said text or computer graphics or from said control parameter at least one compression coding parameter for use in compression coding of the video output.

15. Apparatus according to claim 14, wherein said control parameter is selected from a scrolling rate, a scrolling direction, a repetition rate, a direction, a pixel dimension and a block location.

16. A method of video processing comprising the steps of receiving a text or computer graphics input; receiving at least one control parameter associated with said text or computer graphics; synthesising a video output by at least in part from said text or computer graphics and from said control parameter; and deriving from said text or computer graphics or from said control parameter at least one compression coding parameter for use in compression coding of the video output.

17. A method according to claim 16, wherein said control parameter is selected from a scrolling rate, a scrolling direction, a repetition rate, a direction, a pixel dimension and a block location.

18. A computer program product adapted to implement a method in which the uncompressed output of video origination apparatus is compressed wherein the output of the said video origination apparatus is created or modified in response to the actions of an operator, or received control data; and the said uncompressed output is compressed according to at least one compression coding parameter derived from the said operator action or received control data.

19. A computer program product adapted to implement a method in which the uncompressed output of video modification apparatus is compressed, wherein an uncompressed first video input signal is combined with at least a second uncompressed video signal created or modified in response to the actions of an operator, or received control data; wherein the said uncompressed output is compressed according to at least one compression coding parameter derived from the said operator action or received control data.

20. A computer program product according to claim 19 wherein the said uncompressed first video input is accompanied by related compression coding parameters and the said uncompressed output is compressed according to at least one compression coding parameter taken from the said compression parameters related to the said uncompressed first video input.

21. A computer program product adapted to implement a method of video processing comprising the steps of receiving a text or computer graphics input; receiving at least one control parameter associated with said text or computer graphics; synthesising a video output by at least in part from said text or computer graphics and from said control parameter; and deriving from said text or computer graphics or from said control parameter at least one compression coding parameter for use in compression coding of the video output.

22. A computer program product according to claim 21, wherein said control parameter is selected from a scrolling rate, a scrolling direction, a repetition rate, a direction, a pixel dimension and a block location.

23. A video text generator comprising: an input stage for receiving a text input; a control input for receiving at least one control parameter selected from the group consisting of a scrolling rate, a scrolling direction, a repetition rate, a direction, a pixel dimension and a block location associated with said text or computer graphics; a video synthesiser for synthesising a video output at least in part from said text input and from said control parameter; and a processor for deriving from said text input or from said control parameter at least one compression coding parameter for use in compression coding of the video output.

24. A logo generator comprising: an input stage for receiving a graphics input; a control input for receiving at least one control parameter selected from the group consisting of a scrolling rate, a scrolling direction, a repetition rate, a direction, a pixel dimension and a block location; a video synthesiser for synthesising a video output by at least in part from said graphics and from said control parameter; and a processor for deriving from said graphics or from said control parameter at least one compression coding parameter for use in compression coding of the video output.

25. A method of generating video from a computer graphics input, comprising the steps of receiving a graphics input; synthesising a video output by at least in part from said computer graphics; deriving from said computer graphics at least one compression coding parameter for use in compression coding of the video output; and outputting the video output and the compression coding parameter, with the compression coding parameter being temporally and spatially related with the video output.
